(19) United States
(12) Patent Application Publication
(10) Pub. No.: US 2025/0189221 A1
(43) Pub. Date: Jun. 12, 2025

(54) METHOD FOR REMOVING LIQUID DROPLETS FROM A GAS AND PRESSURIZING THE RESULTING LIQUID

(71) Applicants: Air Liquide Large Industries U.S. LP, Houston, TX (US); L'Air Liquide, Société Anonyme pour l'Etude et l'Exploitation des Procédés Georges Claude, Paris (FR)

(72) Inventors: Gary D. MILLER, Houston, TX (US); Joshua LIGHT, Houston, TX (US)

(21) Appl. No.: 18/530,527

(22) Filed: Dec. 6, 2023

(51) Int. Cl. F25J 3/08

(52) U.S. Cl. CPC F25J 3/08; F25J 2205/10; F25J 2230/32

(57) ABSTRACT

A method for removing entrained liquid droplets from a gas is provided. This method includes introducing a gas with entrained liquid droplets into a cyclone separator, thereby producing a gaseous portion and a liquid portion, wherein the gaseous portion exits the cyclone separator, and wherein the liquid portion is restricted by a liquid control valve and collected in a reservoir volume in the cyclone separator. The method also includes opening the liquid control valve upon receiving a signal from a liquid level sensor located in the reservoir volume, the liquid portion exits the cyclone separator and is introduced into a lock hopper. The method also provides a pressurized vapor stream to the lock hopper, thereby pressurizing the lock hopper, and then withdrawing a pressurized liquid stream from the lock hopper.

### BACKGROUND

It is often necessary for a fluid to experience a phase separation, at which point the liquid phase is essentially at the vaporization point. This is especially true for cryogenic liquids, such as cryogenic hydrogen. Such a fragile liquid is difficult to pressurize in many pumps (such as centrifugal pumps) as they will tend to vaporize at the impeller suction and can produce destructive cavitation. Therefore, there is a need in the industry for a method of pressurizing a liquid stream exiting a phase separator.

Once produced, cryogenic vapor will tend to form liquid droplets as heat transfers from the cold vapor to the warm ambient environment. These entrained liquid droplets may cause problems with downstream equipment such as compressors. A chevron-type separator may be used to remove these entrained liquid droplets but can be overwhelmed if there is too much liquid and therefore allowing destructive liquid to pass-through. This can also be a significant problem with non-cryogenic fluids as well. There is a need in the industry for an improved method for removing entrained liquid droplets from a cryogenic vapor stream.

### SUMMARY

A method for removing entrained liquid droplets from a gas is provided. This method includes introducing a gas with entrained liquid droplets into a cyclone separator, thereby producing a gaseous portion and a liquid portion, wherein the gaseous portion exits the cyclone separator, and wherein the liquid portion is restricted by a liquid control valve and collected in a reservoir volume in the cyclone separator. The method also includes opening the liquid control valve upon receiving a signal from a liquid level sensor located in the reservoir volume, the liquid portion thereby exits the cyclone separator and is introduced into a lock hopper. The method also provides a pressurized vapor stream to the lock hopper, thereby pressurizing the lock hopper, and then withdrawing a pressurized liquid stream from the lock hopper.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of the “first transition” phase of the system to phase separate and pressurize a liquid, in accordance with one embodiment of the present invention.

FIG. 2 is a schematic representation of the “liquid filling” phase of the system to phase separate and pressurize a liquid, in accordance with one embodiment of the present invention.

FIG. 3 is a schematic representation of the “second transition” phase of the system to phase separate and pressurize a liquid, in accordance with one embodiment of the present invention.

FIG. 4 is a schematic representation of the “liquid pressurizing” phase of the system to phase separate and pressurize a liquid, in accordance with one embodiment of the present invention.

FIG. 5 is a schematic representation of the “liquid at pressure” phase of the system to phase separate and pressurize a liquid, in accordance with one embodiment of the present invention.

FIG. 6 is a schematic representation of the “liquid draining” phase of the system to phase separate and pressurize a liquid, in accordance with one embodiment of the present invention.

FIG. 7 is a schematic representation of the “third transition” phase of the system to phase separate and pressurize a liquid, in accordance with one embodiment of the present invention.

FIG. 8 is a schematic representation of the “system venting” phase of the system to phase separate and pressurize a liquid, in accordance with one embodiment of the present invention.

FIG. 9 is a schematic representation of another system to phase separate and pressurize a liquid, in accordance with one embodiment of the present invention.

### ELEMENT NUMBERS

101=feed stream
102=cyclone separator
103=vacuum insulation volume
104=vapor stream
105=liquid stream
106=cyclone separator barrel
107=cyclone separator cone
108=liquid volume
109=liquid level sensor
110=liquid control valve
111=liquid level signal
112=first liquid control valve
113=lock hopper
114=level transmitter
115=pressure sensor
116=liquid stream to storage
117=second liquid control valve
118=gaseous stream
119=gaseous vent stream
120=gaseous pressurized stream
121=vent control valve
122=pressurized control valve
123=liquid vapor separator (chevron-type)
124=chevron separators
125=second vapor stream
126=second liquid stream
127=combined liquid stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

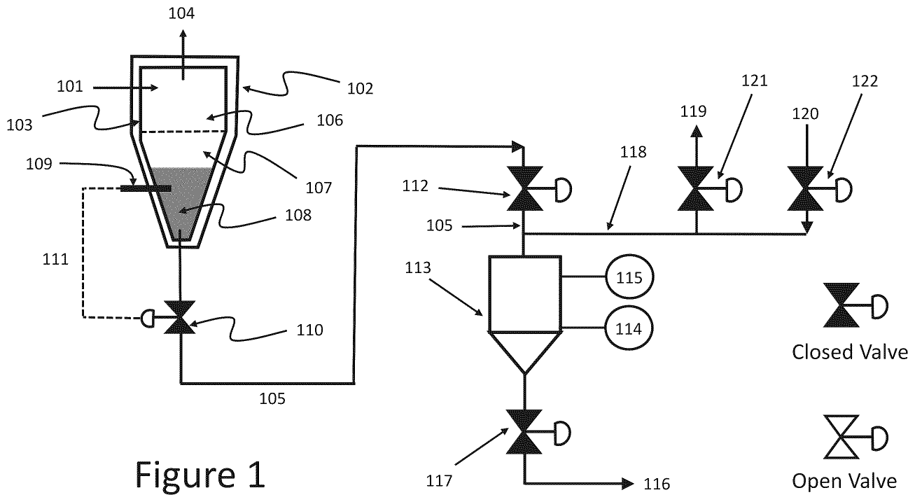

Turning to FIG. 1, a liquid removal system, in accordance with one embodiment of the present invention, is provided. Feed stream 101 is a fluid stream that contains droplets of entrained liquid. Feed stream 101 is introduced into cyclone separator 102, thereby producing vapor stream 104 and liquid stream 105. Cyclone separator 102 may include a vacuum insulation volume 103.

Cyclone separator 102 may be of any design known in the art that is configured to separate small droplets of entrained liquid from a vapor stream. As indicated in FIG. 1, internally the cyclone separator is made up of two main regions: barrel 106 and cone 107. The fluid that is to be separated is introduced into barrel 106 at high velocity. The fluid spirals within barrel 106 in a descending helical pattern. The centrifugal forces separate the higher density liquid from the lower density gas. The higher density liquid collects along the inner wall of barrel 106 and descends. As the spiraling fluid continues to descend within cyclone separator 102, at least a portion will enter cone 107. As this fluid descends further, it accelerates, thus more aggressively separating the liquid from the gas. The separated gas then travels upward through the helically spinning gas and exits as vapor stream 104. The liquid that has been making its way down the inner wall of barrel 106 and cone 107 eventually exits as liquid stream 105.

Cyclone separator 102 also includes a reservoir area in barrel 107, with liquid level sensor 109 which is configured to sense the presence of liquid volume 108. Liquid level sensor 109 sends liquid level signal 111 to liquid control valve 110. As long as the level of liquid volume 108 remains below a predetermined level as measured by liquid level sensor 109, liquid control valve 110 remains closed. As the level of liquid volume 108 exceeds the predetermined level as measured by liquid level sensor 109, liquid control valve 110 opens, thus allowing liquid 108 to leave the system as liquid stream 105.

Liquid stream 105 passes through first liquid control valve 112, then into lock hopper 113. The liquid level inside lock hopper 113 is measured by level transmitter 114. The pressure inside lock hopper 113 is measured by pressure sensor 115. Pressurized liquid stream 116 exists lock hopper 113 and passes through second liquid control valve 117. Gaseous stream 118 is fluidically connected to the system between first liquid control valve 112 and lock hopper 113, thereby allowing fluid to enter or exit from this flow path. Gaseous stream 118 is fluidically connected to gaseous vent stream 119 and gaseous pressurized stream 120. The flow of gaseous that is vented as gaseous vent stream 119 is controlled by vent control valve 121. The flow of pressurized stream 120 that exits gaseous stream 118 is controlled by pressurized control valve 122. In subsequent Figures, a control valve that is not filled indicates that that control valve is open, and a control valve that is filled in indicates that that control valve is closed, as indicated in FIG. 1. The above system will work on any two-phase fluid, or any liquid fluid that is sufficiently reduced in pressure upon entering cyclone separator 102 to become two-phase.

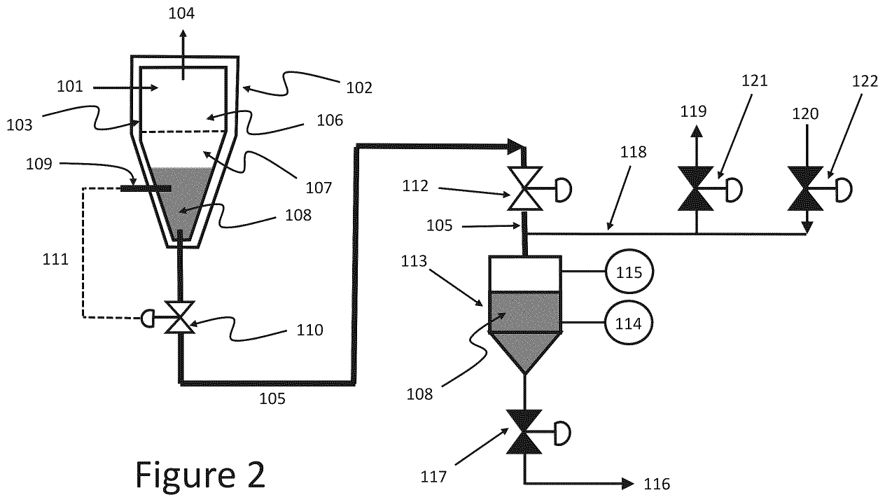

Turning to FIG. 2, the step which may be referred to as “liquid filling” phase, according to one embodiment of the present invention is provided. Liquid control valve 110 and first liquid control valve 112 are opened, thereby allowing liquid 108 to flow into lock hopper 113 by means of gravity. Liquid stream 108 accumulates within lock hopper 113. In this step, second liquid control valve 117, vent control valve 121, and pressurized control valve 122 are all closed. Lock hopper 113 and cyclone separator 102 are at approximately the same pressure.

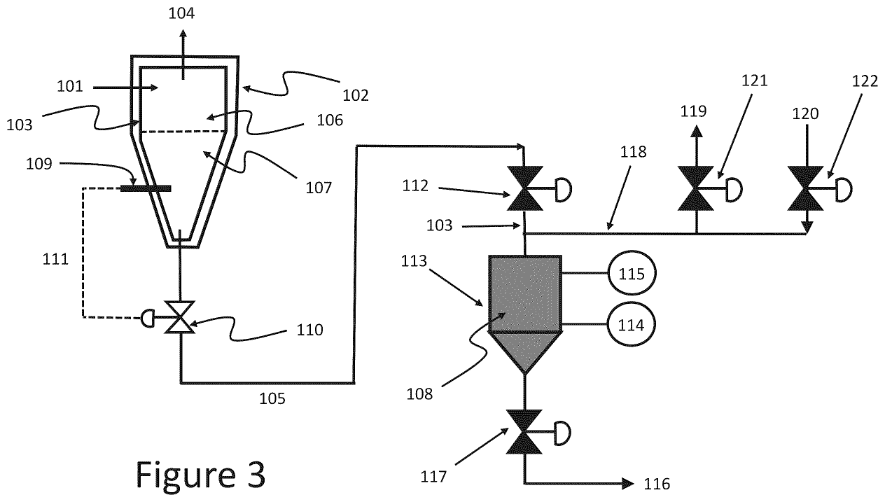

Turning to FIG. 3, the step which may be referred to as the “second transition” phase, according to one embodiment of the present invention is provided. First liquid control valve 112 is closed when level transmitter 114 reaches its setpoint, thereby preventing any further liquid phase stream from flowing into lock hopper 113. At this time, lock hopper 113 will contain the desired amount of liquid 108. In this step, first liquid control valve 112, second liquid control valve 117, vent control valve 121, and pressurized control valve 122 are all closed, and lock hopper 113 and cyclone separator 102 remain at approximately the same pressure.

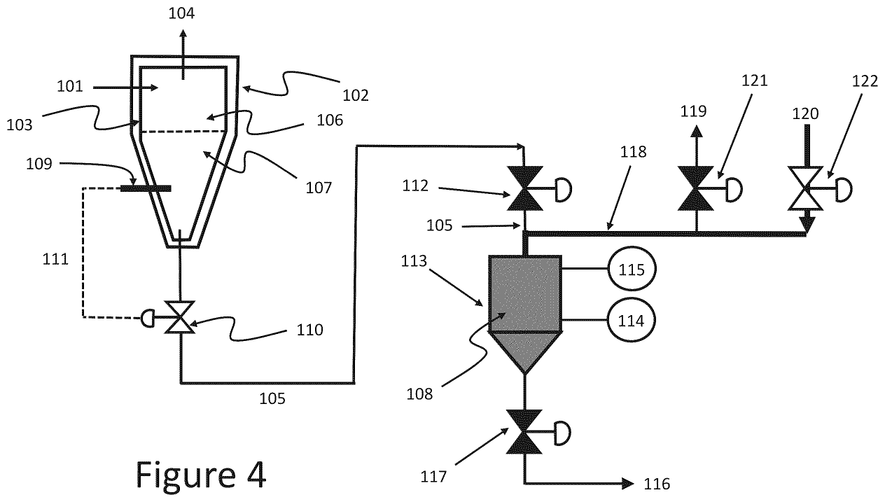

Turning to FIG. 4, the step which may be referred to as “liquid pressurizing” phase, according to one embodiment of the present invention is provided. Pressurized control valve 122 is opened, thereby allowing pressurized vapor 120 to flow into lock hopper 113, thereby pressurizing it. In this step, first liquid control valve 112, second liquid control valve 117, and vent control valve 121 are all closed, and pressure sensor 115 should measure a pressure which is at least adequate to force liquid 108, through the downstream system. Lock hopper 113 and cyclone separator 102 are at different pressures.

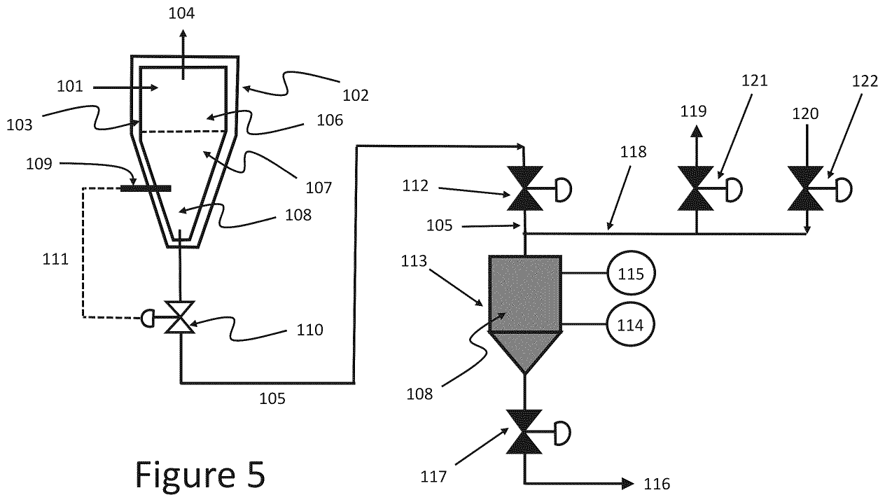

Turning to FIG. 5, the step which may be referred to as the “liquid at pressure” phase, according to one embodiment of the present invention is provided. Pressurized control valve 122 is now closed, thereby preventing pressurized vapor 120 from flowing into lock hopper 113 and maintaining lock hopper 113 at the desired pressure. In this step, first liquid control valve 112, second liquid control valve 117, vent control valve 121, and pressurized control valve 122 are all closed, and pressure sensor 115 should measure a pressure which is at least adequate to force liquid 108, through the downstream system. Lock hopper 113 and cyclone separator 102 are at different pressures.

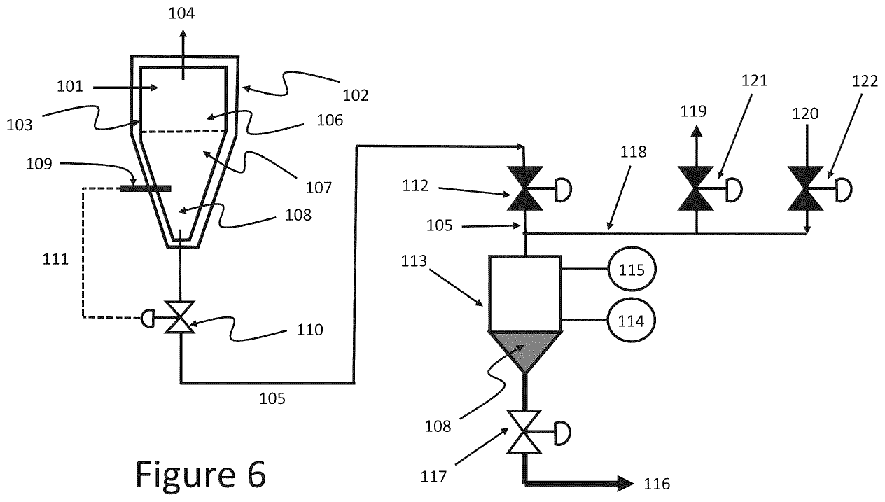

Turning to FIG. 6, the step which may be referred to as “liquid draining” phase, according to one embodiment of the present invention is provided. Second liquid control valve 117 is opened, thereby allowing pressurized liquid 108 to flow out of lock hopper 113, thereby emptying it. In this step, first liquid control valve 112, vent control valve 121 and pressurized control valve 122 are all closed, and pressure sensor 115 should measure a pressure which is dropping to the desired lower pressure. Lock hopper 113 and cyclone separator 102 are approaching approximately the same pressure.

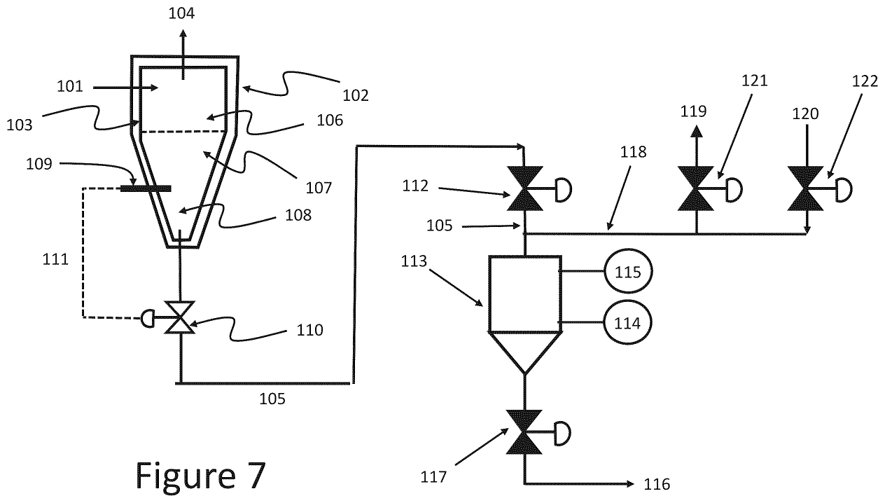

Turning to FIG. 7, the step which may referred to as the “third transition” phase, according to one embodiment of the present invention is provided. This step is the completion of the liquid removal from the system. In the present step, first liquid control valve 112, second liquid control valve 117, vent control valve 121, and pressurized control valve 122 are all closed, and cyclone separator 102 and lock hopper 113 are approaching the same pressure.

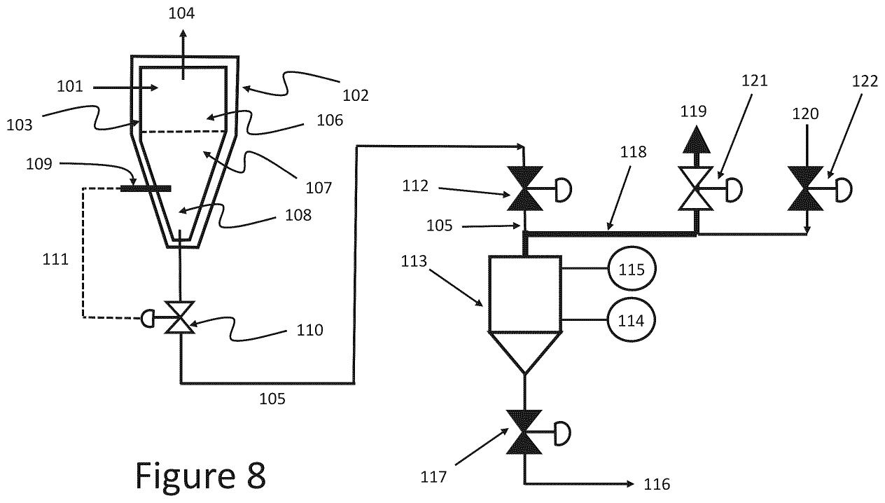

Turning to FIG. 8, the step which may be referred to as “system venting” phase, according to one embodiment of the present invention is provided. Vent control valve 121 is opened, thereby allowing any residual vapors to flow out of lock hopper 113, thereby bringing its pressure to its desired value. In this step, first liquid control valve 112, second liquid control valve 117 and pressurized control valve 122 are all closed, and lock hopper 113 and cyclone separator 102 remain at approximately the same pressure. This step anticipates a repeat of the “first transition step, as described above with FIG. 2.

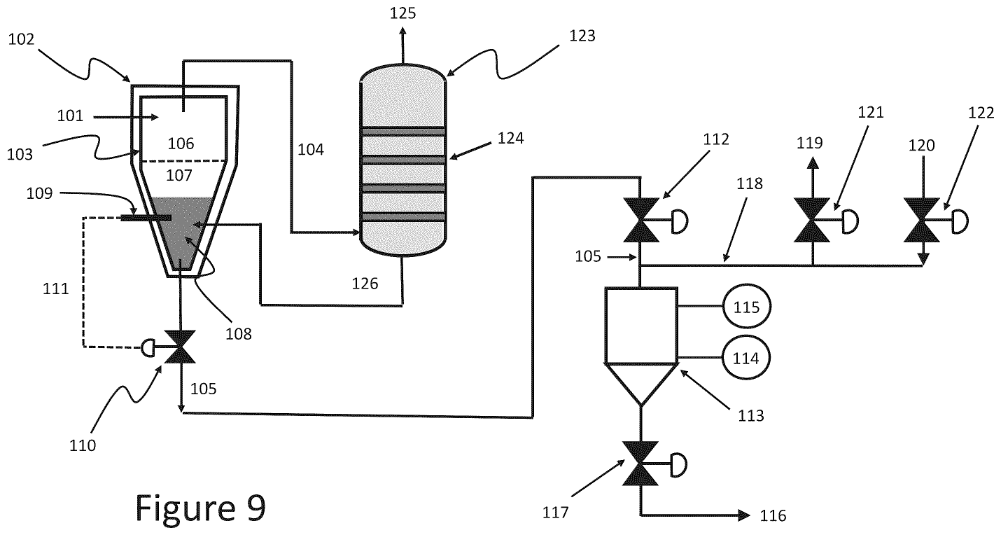

Turning to FIG. 9, the combination of cyclone separator 102 and lock hopper 113 allows a two-stage separation process. Cyclone separator 102 will remove a considerable amount of the liquid present in feed stream 101, thus “unloading” lock hopper 113. This arrangement is especially advantageous if slugs of liquid may typically enter the separation system. Cyclone separator 102 thus offers a potentially critical layer of protection for the overall system. This is especially critical if the downstream system has a low tolerance for entrained liquid droplets in the gas phase.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

Turning again to FIG. 1, a liquid removal system, in accordance with another embodiment of the present invention, is provided. Cryogenic feed stream 101 is a cryogenic fluid stream that contains droplets of entrained cryogenic liquid. Cryogenic feed stream 101 is introduced into cyclone separator 102, thereby producing cryogenic vapor stream 104 and cryogenic liquid stream 105. Cyclone separator 102 may include a vacuum insulation volume 103. In this non-limiting example, the fluid is cryogenic. In a preferred embodiment, the fluid is hydrogen. The non-limiting example described below uses two-phase hydrogen, but the steps and phases described are applicable to any appropriate fluid.

Cyclone separator 102 may be of any design known in the art that is configured to separate small droplets of entrained cryogenic liquid from a cryogenic vapor stream. As indicated in FIG. 1, internally the cyclone separator is made up of two main regions: barrel 106 and cone 107. The fluid that is to be separated is introduced into barrel 106 at high velocity. The fluid spirals within barrel 106 in a descending helical pattern. The centrifugal forces separate the higher density cryogenic liquid from the lower density cryogenic gas. The higher density cryogenic liquid collects along the inner wall of barrel 106 and descends. As the spiraling fluid continues to descend within cyclone separator 102, at least a portion will enter cone 107. As this fluid descends further, it accelerates, thus more aggressively separating the cryogenic liquid from the cryogenic gas. The separated cryogenic gas then travels upward through the helically spinning cryogenic gas and exits as cryogenic vapor stream 104. The cryogenic liquid that has been making its way down the inner wall of barrel 106 and cone 107 eventually exits as cryogenic liquid stream 105.

Cyclone separator 102 also includes a reservoir area in cone 107, with liquid level sensor 109 which is configured to sense the presence of cryogenic liquid volume 108. Liquid level sensor 109 sends liquid level signal 111 to liquid control valve 110. As long as the level of cryogenic liquid volume 108 remains below a predetermined level as measured by liquid level sensor 109, liquid control valve 110 remains closed. As the level of cryogenic liquid volume 108 exceeds the predetermined level as measured by liquid level sensor 109, liquid control valve 110 opens, thus allowing cryogenic liquid 108 to leave the system as cryogenic liquid stream 105.

Cryogenic liquid stream 105 passes through first liquid control valve 112, then into lock hopper 113. The cryogenic liquid level inside lock hopper 113 is measured by level transmitter 114. The pressure inside lock hopper 113 is measured by pressure sensor 115. Pressurized cryogenic liquid stream 116 exists lock hopper 113 and passes through second liquid control valve 117. Gaseous stream 118 is fluidically connected to the system between first liquid control valve 112 and lock hopper 113, thereby allowing fluid to enter or exit from this flow path. Gaseous stream 118 is fluidically connected to gaseous vent stream 119 and pressurized gaseous stream 120. The flow of gaseous that is vented as gaseous vent stream 119 is controlled by vent control valve 121. The flow of pressurized gaseous 120 that exits gaseous stream 118 is controlled by pressurized gas control valve 122. In subsequent Figures, a control valve that is not filled indicates that that control valve is open, and a control valve that is filled in indicates that that control valve is closed, as indicated in FIG. 1. The above system will work on any two-phase fluid, or any liquid fluid that is sufficiently reduced in pressure upon entering cyclone separator 102 to become two-phase. In a preferred embodiment, the fluid is cryogenic. In a more preferred embodiment, the fluid is hydrogen. The non-limiting example described below uses two-phase hydrogen, but the steps and phases described are applicable to any appropriate fluid.

Turning to FIG. 2, the step which may be referred to as “liquid filling” phase, according to one embodiment of the present invention is provided. Liquid control valve 110 and first liquid control valve 112 are opened, thereby allowing cryogenic liquid 108 to flow into lock hopper 113 by means of gravity. Cryogenic liquid 108 accumulates within lock hopper 113. In this step, second liquid control valve 117, vent control valve 121, and pressurized gas control valve 122 are all closed. Lock hopper 113 and cyclone separator 102 are at approximately the same pressure.

Turning to FIG. 3, the step which may be referred to as the “second transition” phase, according to one embodiment of the present invention is provided. First liquid control valve 112 is closed when level transmitter 114 reaches its setpoint, thereby preventing any further cryogenic liquid phase fluid from flowing into lock hopper 113. At this time, lock hopper 113 will contain the desired amount of cryogenic liquid 108. In this step, first liquid control valve 112, second liquid control valve 117, vent control valve 121, and pressurized gas control valve 122 are all closed, and lock hopper 113 and cyclone separator 102 remain at approximately the same pressure.

Turning to FIG. 4, the step which may be referred to as “liquid pressurizing” phase, according to one embodiment of the present invention is provided. Pressurized gas control valve 122 is opened, thereby allowing pressurized gaseous stream 120 to flow into lock hopper 113, thereby pressurizing it. In this step, first liquid control valve 112, second liquid control valve 117, and vent control valve 121 are all closed, and pressure sensor 115 should measure a pressure which is at least adequate to force cryogenic liquid 108, through the downstream system. Lock hopper 113 and cyclone separator 102 are at different pressures.

Turning to FIG. 5, the step which may be referred to as the “liquid at pressure” phase, according to one embodiment of the present invention is provided. Pressurized gas control valve 122 is now closed, thereby preventing pressurized gaseous stream 120 from flowing into lock hopper 113 and maintaining lock hopper 113 at the desired pressure. In this step, first liquid control valve 112, second liquid control valve 117, vent control valve 121, and pressurized gas control valve 122 are all closed, and pressure sensor 115 should measure a pressure which is at least adequate to force cryogenic liquid 108, through the downstream system. Lock hopper 113 and cyclone separator 102 are at different pressures.

Turning to FIG. 6, the step which may be referred to as “liquid draining” phase, according to one embodiment of the present invention is provided. Second liquid control valve 117 is opened, thereby allowing pressurized cryogenic liquid 108 to flow out of lock hopper 113, thereby emptying it. In this step, first liquid control valve 112, vent control valve 121 and pressurized gas control valve 122 are all closed, and pressure sensor 115 should measure a pressure which is dropping to the desired lower pressure. Lock hopper 113 and cyclone separator 102 are approaching approximately the same pressure.

Turning to FIG. 7, the step which may referred to as the “third transition” phase, according to one embodiment of the present invention is provided. This step is the completion of the cryogenic liquid removal from the system. In the present step, first liquid control valve 112, second liquid control valve 117, vent control valve 121, and pressurized gas control valve 122 are all closed, and lock hopper 113 and cyclone separator 102 are approaching the same pressure. No other fluids are flowing in this step.

Turning to FIG. 8, the step which may be referred to as “system venting” phase, according to one embodiment of the present invention is provided. Vent control valve 121 is opened, thereby allowing any residual cryogenic vapors to flow out of lock hopper 113, thereby bringing its pressure to its desired value. In this step, first liquid control valve 112, second liquid control valve 117 and pressurized gas control valve 122 are all closed, and lock hopper 113 and cyclone separator 102 remain at approximately the same pressure. This step anticipates a repeat of the “first transition step, as described above with FIG. 2.

The combination of cyclone separator 102 and lock hopper 113 allows a two-stage separation process. Cyclone separator 102 will remove a considerable amount of the cryogenic liquid present in cryogenic feed stream 101, thus “unloading” lock hopper 113. This arrangement is especially advantageous if slugs of cryogenic liquid may typically enter the separation system. Cyclone separator 102 thus offers a potentially critical layer of protection for the overall system. This is especially critical if the downstream system has a low tolerance for entrained cryogenic liquid droplets in the cryogenic gas phase.

Turning to FIG. 9, a liquid removal system, in accordance with yet another embodiment of the present invention, is provided. Feed stream 101 is a fluid stream that contains droplets of entrained liquid. Feed stream 101 is introduced into cyclone separator 102, thereby producing first vapor stream 104 and first liquid stream 105. Cyclone separator 102 may include a vacuum insulation volume 103. Cyclone separator 102 may be of any design known in the art that is configured to separate small droplets of entrained liquid from a vapor stream.

Cyclone separator 102 also includes liquid level sensor 109 which is configured to sense the presence of liquid volume 108. Liquid level sensor 109 sends liquid level signal 111 to liquid control valve 110. As long as the level of liquid volume 108 remains below a predetermined level as measured by liquid level sensor 109, liquid control valve 110 remains closed. Then, as the level of liquid volume 108 exceeds the predetermined level as measured by liquid level sensor 109, liquid control valve 110 opens, thus allowing first liquid stream 105 to leave the system.

First vapor stream 104 then enters liquid vapor separator 123, thereby producing second vapor stream 125 and second liquid stream 126. Liquid vapor separator 123 may contain chevron separators 124 to separate the liquid phase from the vapor phase. Liquid vapor separator 123 may be of any design known in the art. Second vapor stream 125 then exits the system. Second liquid stream 126 is introduced into cone 107, below the level of liquid volume 108. First liquid stream 105 passes through first liquid control valve 112 and then into lock hopper 113.

The combination of cyclone separator 102 and chevron-base separator 123 allows a two-stage separation process. Cyclone separator 102 will remove a considerable amount of the liquid present in feed stream 101, thus “unloading” chevron-base separator 123. This arrangement is especially advantageous if slugs of liquid may typically enter the separation system. Cyclone separator 102 thus offers a potentially critical layer of protection for the overall system. This is especially critical if the downstream system has a low tolerance for entrained liquid droplets in the gas phase.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

Combined liquid stream 127 passes through first liquid control valve 112, then into lock hopper 113. The liquid level inside lock hopper 113 is measured by level transmitter 114. The pressure inside lock hopper 113 is measured by pressure sensor 115. Pressurized liquid stream 116 exists lock hopper 113 and passes through second liquid control valve 117. Gaseous stream 118 is fluidically connected to the system between first liquid control valve 112 and lock hopper 113, thereby allowing fluid to enter or exit from this flow path. Gaseous stream 118 is fluidically connected to gaseous vent stream 119 and gaseous pressurized stream 120. The flow of gaseous that is vented as gaseous vent stream 119 is controlled by vent control valve 121. The flow of pressurized stream 120 that exits gaseous stream 118 is controlled by pressurized control valve 122. The various phases described above are then applied to the system.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

Turning again to FIG. 9, a liquid removal system, in accordance with yet another embodiment of the present invention, is provided. Cryogenic feed stream 101 is a fluid stream that contains droplets of entrained liquid. Cryogenic feed stream 101 is introduced into cyclone separator 102, thereby producing first cryogenic vapor stream 104 and first cryogenic liquid stream 105. Cyclone separator 102 may include a vacuum insulation volume 103. Cyclone separator 102 may be of any design known in the art that is configured to separate small droplets of entrained liquid from a vapor stream.

Cyclone separator 102 also includes liquid level sensor 109 which is configured to sense the presence of cryogenic liquid volume 108. Liquid level sensor 109 sends liquid level signal 111 to liquid control valve 110. As long as the level of cryogenic liquid volume 108 remains below a predetermined level as measured by liquid level sensor 109, liquid control valve 110 remains closed. Then, as the level of cryogenic liquid volume 108 exceeds the predetermined level as measured by liquid level sensor 109, liquid control valve 110 opens, thus allowing first cryogenic liquid stream 105 to leave the system.

First cryogenic vapor stream 104 then enters liquid vapor separator 123, thereby producing second cryogenic vapor stream 125 and second cryogenic liquid stream 126. Liquid vapor separator 123 may contain chevron separators 124 to separate the liquid phase from the vapor phase. Liquid vapor separator 123 may be of any design known in the art. Second cryogenic vapor stream 125 then exits the system. First cryogenic liquid stream 105 and second cryogenic liquid stream 126 are combined and the combined stream and the combined cryogenic liquid stream 127 then passes through first liquid control valve 112 and then into lock hopper 113.

The combination of cyclone separator 102 and chevron-base separator 123 allows a two-stage separation process. Cyclone separator 102 will remove a considerable amount of the liquid present in cryogenic feed stream 101, thus “unloading” chevron-base separator 123. This arrangement is especially advantageous if slugs of liquid may typically enter the separation system. Cyclone separator 102 thus offers a potentially critical layer of protection for the overall system. This is especially critical if the downstream system has a low tolerance for entrained liquid droplets in the gas phase.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

Combined cryogenic liquid stream 127 passes through first liquid control valve 112, then into lock hopper 113. The liquid level inside lock hopper 113 is measured by level transmitter 114. The pressure inside lock hopper 113 is measured by pressure sensor 115. Pressurized cryogenic liquid stream 116 exists lock hopper 113 and passes through second liquid control valve 117. Gaseous stream 118 is fluidically connected to the system between first liquid control valve 112 and lock hopper 113, thereby allowing fluid to enter or exit from this flow path. Gaseous stream 118 is fluidically connected to gaseous vent stream 119 and gaseous pressurized stream 120. The flow of gaseous that is vented as gaseous vent stream 119 is controlled by vent control valve 121. The flow of pressurized stream 120 that exits gaseous stream 118 is controlled by pressurized control valve 122. The various phases described above are then applied to the system.

The above system will work on any fluid stream that contains droplets of entrained liquid. In a preferred embodiment, the fluid is cryogenic. In a more preferred embodiment, the fluid is hydrogen. The non-limiting example described below uses two-phase hydrogen, but the steps and phases described are applicable to any appropriate fluid.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for removing entrained liquid droplets from a gas, comprising:
a) introducing a gas with entrained liquid droplets into a cyclone separator, thereby producing a gaseous portion and a liquid portion,
wherein the gaseous portion exits the cyclone separator,
wherein the liquid portion is restricted by a liquid control valve and collected in a reservoir volume in the cyclone separator,
b) opening the liquid control valve upon receiving a signal from a liquid level sensor located in the reservoir volume, the liquid portion thereby exiting the cyclone separator and being introduced into a lock hopper,
c) providing a pressurized vapor stream to the lock hopper, thereby pressurizing the lock hopper,
d) withdrawing a pressurized liquid stream from the lock hopper.

2. The method of claim 1, further comprising e) venting the lock hopper once the lock hopper is empty of pressurized liquid.

3. The method of claim 1, wherein the fluid is a cryogenic fluid.

4. The method of claim 1, wherein the fluid is hydrogen.

5. The method of claim 1, further comprising:
e) introducing the vapor portion exiting the cyclone separator into a chevron-type liquid-vapor separator, thereby producing a secondary gaseous portion and a secondary liquid portion.
